(19) United States
(12) Patent Application Publication
(10) Pub. No.: US 2022/0156458 A1
(43) Pub. Date: May 19, 2022

(54) METHOD AND SERVER FOR DETERMINING A TRAINING SET FOR TRAINING A MACHINE LEARNING ALGORITHM (MLA)

(71) Applicant: YANDEX EUROPE AG, Luzem (CH)

(72) Inventors: ANNA VERONIKA YUREVNA DOROGUSH, Moscow (RU); Vyacheslav Vyacheslavovich ALIPOV, Tomsk (RU); DMITRIY ANDREEVICH KRUCHININ, Shatki (RU); DMITRY ALEKSEEVICH OGANESYAN, Moscow (RU)

(21) Appl. No.: 17/531,321

(22) Filed: Nov. 19, 2021

(30) Foreign Application Priority Data
Nov. 19, 2020 (RU) 2020138004

(51) Int. Cl. G06F 40/20; G06N 20/00; G06F 16/93

(52) U.S. Cl. CPC G06F 40/20; G06F 16/93; G06N 20/00

(57) ABSTRACT

Methods and servers for determining a training set for training a Machine Learning Algorithm (MLA) to perform classification of the digital objects are provided. A server acquires and orders training examples into an ordered sequence. A given training example has previous and subsequent examples in the ordered sequence. The server generates at least one of a textual feature and an embedding-based feature for the given example based on textual data and embedding-based data and the ground-truth classes, respectively, only in the previous training examples in the ordered sequence without taking into account the subsequent examples. The server determines the training set for the MLA having a training input and a label. The training input includes at least one of the textual feature and the embedding-based feature, and the label is representative of the ground-truth class of the respective object.

### CROSS-REFERENCE

The present application claims priority to Russian Patent Application No. 2020138004, entitled “Method and Server for Determining a Training Set for Training a Machine Learning Algorithm”, filed Nov. 19, 2020, the entirety of which is incorporated herein by reference.

### FIELD

The present technology relates to systems and methods for generating machine-learning models. In particular, the present technology is directed to a method of and a system for determining a training set for training a Machine Learning Algorithm (MLA).

### BACKGROUND

Machine learning algorithms (MLAs) are used to address multiple needs in computer-implemented technologies. Typically, MLAs are used for generating a prediction based on data provided thereto. There are many different types of MLAs known in the art and are generally grouped into three groups: supervised learning based MLAs, unsupervised learning based MLAs and reinforcement learning based MLAs.

One example of supervised learning MLAs are called “decision-tree” models. This type of MLA uses a decision tree to go from observations about an item (represented in the branches) to conclusions about the item's target value (represented in the leaves). In order for the decision-tree based MLA to work, it needs to be “built” or trained using a training set of objects containing a large plurality of training objects (such as documents, events, or the like).

Some MLAs are referred to as “classifiers” and are generally configured to classify objects into one or more classes. In other words, some MLAs are configured for solving the problem of identifying to which of a set of categories (sub-populations) a new observation belongs, these MLAs having been trained on the basis of a training set of data containing observations (or instances) whose category membership is known.

A resulting predicted class may be used as additional information about a given object for providing better online electronic services to consumers. For example, information obtained from object classification can be used by search engine services (e.g., document classification), content recommendation services (e.g., content classification), email services (e.g., email classification), e-market services (e.g., user classification), and the like.

For example, a classifier can be trained on a training dataset associated with an object and which comprises information associated with the object and a ground-truth class of the object. The classifier learns what information about the object is more likely indicative of the ground-truth class of training objects. The classifier is then used to determine a predicted class of an in-use object based on information available for that in-use object.

Incorrect classification of objects can introduce bias during further object processing and is generally detrimental to the quality of online services requiring such classification.

U.S. Pat. No. 8,572,071 entitled “Systems and methods for data transformation using higher order learning” and issued on Oct. 29, 2013, discloses a method and apparatus for transforming data in vector form. Each vector is composed of a set of attributes that are either boolean or have been mapped to boolean form. The vectors may or may not fall into categories assigned by a subject matter expert (SME). If categories exist, the categorical labels divide the vectors into subsets. The first transformation calculates a prior probability for each attribute based on the links between attributes in each subset of the vectors. The second transformation computes a new numeric value for each attribute based on the links between attributes in each subset of the vectors. The third transformation operates on vectors that have not been categorized. Based on the automatic selection of categories from the attributes, this transformation computes a new numeric value for each attribute based on the links between attributes in each subset of the vectors.

### SUMMARY

Embodiments of the present technology have been developed based on developers' appreciation of at least one technical problem associated with the prior art approaches to supervised machine learning techniques.

Developers of the present technology have identified one or more drawbacks with computer-implemented techniques for training Machine Learning Algorithms (MLAs). One existing problem with MLA training is called “over-fitting” or “over-training”. Broadly speaking, an over-fitted prediction model produces relatively low prediction errors on training data yet produces relatively high errors on in-use data (i.e. data that it has not seen during the training phase). In other words, over-fitting occurs when the prediction model begins to, in a sense, “memorize” training data rather than learning to generalize from a trend. Over-fitting usually occurs when the prediction model is complex, such as having too many parameters in comparison to the number of observations, for example. Developers of the present technology have devised methods and systems for potentially avoiding over-fitting when training prediction models. In some embodiments, it can be said that the methods and systems disclosed herein may at least reduce the risk and/or impact of over-fitting during the in-use phase of a prediction model.

As it will be described in greater detail herein further below, developers of the present technology have devised methods and systems for generating “training features” to be used for training a decision-tree model in a supervised manner.

Training features generated in the context of the present technology may comprise one or both of “textual features” and “embedding-based features”. It is contemplated that a given textual feature can be generated for a respective digital object based on (i) textual information about the respective digital object, and (ii) textual information about at least one “preceding digital object” to the respective digital object. It is also contemplated that a given embedding-based feature can be generated for a respective digital object based on (i) embedding-based information about the respective digital object, and (ii) embedding-based information about at least one “preceding digital object” to the respective digital object.

In the context of the present technology, training objects used during the training phase of the classification model are “ordered” into a sequence of training objects. In some embodiments, the training objects may be randomly ordered. In other embodiments, the training objects may be ordered based on one or more “object-inherent” characteristic. For example, the training objects may be ordered based on temporal information about the training objects.

Once the textual and/or embedding-based features are so-generated for the respective training objects, the prediction model may be trained for learning to classify objects. Developers of the present technology have realized that generating textual and/or embedding-based training features for training objects (i) while taking into account information about the previous training objects in the sequence and (ii) without taking into account information about the subsequent training objects in the sequence may increase the classification performance of the model. It can be said that so-generating textual and/or embedding-based features for respective training datasets may allow at least reducing over-fitting of the classification model.

It should be noted that a gradient boosting algorithm may be used for training the classification model based on training datasets comprising respective textual and/or embedding-based training features. In some embodiments of the present technology, a gradient boosting technique can be implemented as a part of the CatBoost library. The CatBoost library and additional information regarding gradient boosting algorithms is available at https://catboost. ai. Thus it can be said, at least some embodiments of the present technology can be implemented in accordance with the CatBoost framework.

It should be noted that in at least some decision-tree based models, such as when used in conjunction with gradient boosting techniques, the leaves of the trees may contain numerical values, and branches represent conjunctions of features. The numerical values can be combined and compared against one or more thresholds, for example, for classifying object.

In a first broad aspect of the present technology, there is provided a method of determining a training set for training a Machine Learning Algorithm (MLA) to perform classification of the digital objects. The method is executable by a server. The server executes the MLA. The method comprises acquiring, by the server, a plurality of training examples for training the MLA. A given training example includes textual data associated with a respective object and an indication of a ground-truth class of the respective object. The method comprises ordering, by the server, the plurality of training examples into an ordered sequence of training example. The given training example has previous training examples in the ordered sequence and subsequent training examples in the ordered sequence. The method comprises generating, by the server, a textual feature for the given training example based on the textual data in the given training example and the textual data and the ground-truth classes of only the previous training examples in the ordered sequence without taking into account textual data in the subsequent training examples. The method comprises determining, by the server, the training set for the MLA based on the given training example. The training set has a training input and a label. The training input includes the textual feature, and the label is representative of the ground-truth class of the respective object.

In some embodiments of the method, the training input further includes the textual data of the respective object, and the textual data for inputting with the textual feature into the MLA.

In some embodiments of the method, the method further comprises training, by the server, the MLA based on the training set. The MLA is trained to use inputs for generating respective predicted classes.

In some embodiments of the method, the object is a digital document providable as a search result in response to a query.

In some embodiments of the method, the object is a digital item recommendable to a user of a content recommendation system.

In some embodiments of the method, the object is an email destined to a user of an email platform.

In some embodiments of the method, the method further comprises storing, by the server, data indicative of the plurality of training examples in a storage.

In some embodiments of the method, the generating the textual feature comprises employing, by the server, at least one of: a Naïve Bayes function, a Term-Frequency-Inverse-Document-Frequency (TF-IDF) function, and a Best-Matching-25 (BM25) function.

In some embodiments of the method, the method further comprises storing, by the server, data indicative of a plurality of training sets in a storage. The plurality of training sets includes the training set.

In some embodiments of the method, the method further comprises acquiring, by the server, a given in-use example for the MLA, where the given in-use example includes textual data associated with a respective in-use object. The method further comprises generating, by the server, an in-use textual feature for the given in-use example based on the textual data in the given in-use example and the textual data stored in the storage. The method further comprises inputting, by the server, a given in-use input into the MLA, the given in-use input including the in-use textual feature. the MLA is configured to determine a predicted class of the respective in-use object.

In some embodiments of the method, the given in-use input further comprises the textual data of the respective in-use object.

In some embodiments of the method, the MLA is trained to perform binary classification of objects.

In some embodiments of the method, the MLA is trained to perform multi-class classification of objects.

In some embodiments of the method, the MLA is of a decision-tree type.

In a second broad aspect of the present technology, there is provided a server for determining a training set for training a Machine Learning Algorithm (MLA) to perform classification of the digital objects. The server executes the MLA. The server is configured to acquire a plurality of training examples for training the MLA. A given training example includes textual data associated with a respective object and an indication of a ground-truth class of the respective object. The server is configured to order the plurality of training examples into an ordered sequence of training examples. The given training example has previous training examples in the ordered sequence and subsequent training examples in the ordered sequence. The server is configured to generate a textual feature for the given training example based on the textual data in the given training example and the textual data and the ground-truth classes of only the previous training examples in the ordered sequence without taking into account textual data in the subsequent training examples. The server is configured to determine the training set for the MLA based on the given training example. The training set has a training input and a label. The training input includes the textual feature. The label is representative of the ground-truth class of the respective object.

In some embodiments of the server, the training input further includes the textual data of the respective object, and the textual data is to be inputted by the server with the textual feature into the MLA.

In some embodiments of the server, the server is further configured to train the MLA based on the training set. The MLA is trained to use inputs for generating respective predicted classes.

In some embodiments of the server, the object is a digital document providable as a search result in response to a query.

In some embodiments of the server, the object is a digital item recommendable to a user of a content recommendation system.

In some embodiments of the server, the object is an email destined to a user of an email platform.

In some embodiments of the server, the server is further configured to store data indicative of the plurality of training examples in a storage.

In some embodiments of the server, the generating the textual feature comprises employing, by the server, at least one of: a Naïve Bayes function, a Term-Frequency-Inverse-Document-Frequency (TF-IDF) function, and a Best-Matching-25 (BM25) function.

In some embodiments of the server, the server is further configured to store data indicative of a plurality of training sets in a storage, the plurality of training sets including the training set.

In some embodiments of the server, the server is further configured to acquire a given in-use example for the MLA, where the given in-use example includes textual data associated with a respective in-use object. The server is further configured to generate an in-use textual feature for the given in-use example based on the textual data in the given in-use example and the textual data stored in the storage. The server is further configured to input a given in-use input into the MLA. The given in-use input includes the in-use textual feature. The MLA is configured to determine a predicted class of the respective in-use object.

In some embodiments of the server, the given in-use input further comprises the textual data of the respective in-use object.

In some embodiments of the server, the MLA is trained to perform binary classification of objects.

In some embodiments of the server, the MLA is trained to perform multi-class classification of objects.

In some embodiments of the server, the MLA is of a decision-tree type.

In a third broad aspect of the present technology, there is provided a method of determining a training set for training a Machine Learning Algorithm (MLA) to perform classification of the digital objects, The method is executable by a server. The server executes the MLA. The method comprises acquiring, by the server, a plurality of training examples for training the MLA. A given training example includes an embedding associated with a respective object and an indication of a ground-truth class of the respective object. The method comprises ordering, by the server, the plurality of training examples into an ordered sequence of training examples. The given training example has previous training examples in the ordered sequence and subsequent training examples in the ordered sequence. The method comprises generating, by the server, an embedding-based feature for the given training example based on the embedding in the given training example and the embeddings and the ground-truth classes of only the previous training examples in the ordered sequence without taking into account embeddings in the subsequent training examples. The method comprises determining, by the server, the training set for the MLA based on the given training example. The training set has a training input and a label. The training input includes the embedding-based feature. The label is representative of the ground-truth class of the respective object.

In some embodiments of the method, the training input further includes the embedding of the respective object, and the embedding is for inputting with the embedding-based feature into the MLA.

In some embodiments of the method, the method further comprises training, by the server, the MLA based on the training set. The MLA is trained to use inputs for generating respective predicted classes.

In some embodiments of the method, the object is a digital document providable as a search result in response to a query.

In some embodiments of the method, the object is a digital item recommendable to a user of a content recommendation system.

In some embodiments of the method, the object is an email destined to a user of an email platform.

In some embodiments of the method, the method further comprises storing, by the server, data indicative of the plurality of training examples in a storage.

In some embodiments of the method, the generating the embedding-based feature comprises determining, by the server, at least one of: a cosine distance between the embedding and an average embedding for a given class of the previous training examples, a euclidean distance between the embedding and K number of nearest neighbors from the given class of the previous training examples.

In some embodiments of the method, the method further comprises generating, by the server, the embedding for the given training example based on textual data associated with the given object.

In some embodiments of the method, the embedding is generated by employing at least one of: a word2vec algorithm, a fastText algorithm, and a GloVe algorithm.

In some embodiments of the method, the method further comprises generating, by the server, the embedding for the given training example based on image data associated with the given object.

In some embodiments of the method, the method further comprises storing, by the server, data indicative of a plurality of training sets in a storage, and where the plurality of training sets includes the training set.

In some embodiments of the method, the method further comprises acquiring, by the server, a given in-use example for the MLA, where the given in-use example includes an in-use embedding associated with a respective in-use object. The method further comprises generating, by the server, an in-use embedding-based feature for the given in-use example based on the in-use embedding in the given in-use example and embedding-based data stored in the storage. The method further comprises inputting, by the server, a given in-use input into the MLA, the given in-use input including the in-use embedding-based feature. The MLA is configured to determine a predicted class of the respective in-use object.

In some embodiments of the method, the in-use input further includes the in-use embedding associated with the in-use object.

In some embodiments of the method, the MLA is trained to perform binary classification of objects.

In some embodiments of the method, the MLA is trained to perform multi-class classification of objects.

In some embodiments of the method, the MLA is of a decision-tree type.

In a fourth broad aspect of the present technology, there is provided a server for determining a training set for training a Machine Learning Algorithm (MLA) to perform classification of the digital objects. The server executes the MLA. The server is configured to acquire a plurality of training examples for training the MLA. A given training example includes an embedding associated with a respective object and an indication of a ground-truth class of the respective object. The server is configured to order the plurality of training examples into an ordered sequence of training examples. The given training example has previous training examples in the ordered sequence and subsequent training examples in the ordered sequence. The server is configured to generate an embedding-based feature for the given training example based on the embedding in the given training example and the embeddings and the ground-truth classes of only the previous training examples in the ordered sequence without taking into account embeddings in the subsequent training examples. The server is configured to determinee the training set for the MLA based on the given training example. The training set has a training input and a label. The training input includes the embedding-based feature. The label is representative of the ground-truth class of the respective object.

In some embodiments of the server, the training input further includes the embedding of the respective object, and where the embedding is to be inputted with the embedding-based feature into the MLA.

In some embodiments of the server, the server is further configured to train the MLA based on the training set. The MLA is trained to use inputs for generating respective predicted classes.

In some embodiments of the server, the object is a digital document providable as a search result in response to a query.

In some embodiments of the server, the object is a digital item recommendable to a user of a content recommendation system.

In some embodiments of the server, the object is an email destined to a user of an email platform.

In some embodiments of the server, the server is configured to store data indicative of the plurality of training examples in a storage.

In some embodiments of the server, the generating the embedding-based feature comprises determining, by the server, at least one of: a cosine distance between the embedding and an average embedding for a given class of the previous training examples, a euclidean distance between the embedding and K number of nearest neighbors from the given class of the previous training examples.

In some embodiments of the server, the server is further configured to generate the embedding for the given training example based on textual data associated with the given object.

In some embodiments of the server, the embedding is generated by employing at least one of: a word2vec algorithm, a fastText algorithm, and a GloVe algorithm.

In some embodiments of the server, the server is further configured to generate the embedding for the given training example based on image data associated with the given object.

In some embodiments of the server, the server is further configured to store data indicative of a plurality of training sets in a storage, where the plurality of training sets includes the training set.

In some embodiments of the server, the server is further configured to acquire a given in-use example for the MLA, where the given in-use example includes an in-use embedding associated with a respective in-use object. The server is further configured to generate an in-use embedding-based feature for the given in-use example based on the in-use embedding and embedding-based data stored in the storage. The server is configured to input a given in-use input into the MLA, the given in-use input including the embedding-based data of the respective in-use object and the in-use embedding-based feature. The MLA is configured to determine a predicted class of the respective in-use object.

In some embodiments of the server, the given in-use input further includes the in-use embedding associated with the respective in-use object.

In some embodiments of the server, the MLA is trained to perform binary classification of objects.

In some embodiments of the server, the MLA is trained to perform multi-class classification of objects.

In some embodiments of the server, the MLA is of a decision-tree type.

In yet another broad aspect of the present technology, there is provided a method of determining a training set for training a Machine Learning Algorithm (MLA) to perform classification of the digital objects. The method executable by a server. The server executes the MLA. The method comprises acquiring, by the server, a plurality of training examples for training the MLA. A given training example includes object-specific data associated with a respective digital object and an indication of a ground-truth class of the respective object. The method comprises ordering, by the server, the plurality of training examples into an ordered sequence of training examples. The given training example has previous training examples in the ordered sequence and subsequent training examples in the ordered sequence. The method comprises clustering, by the server, the previous training examples into at least two clusters of previous training examples in a multidimensional space. Previous training examples in a given cluster is associated with a first ground-truth class. The method comprises generating, by the server, a similarity feature for the given training example based on a distance between the given cluster and the given training example in the multidimensional space. The similarity feature is indicative of a similarity between the given training example and the previous training examples of the first ground-truth class. The method comprises determining, by the server, the training set for the MLA based on the given training example. The training set has a training input and a label. The training input includes the similarity feature. The label is representative of the ground-truth class of the respective object.

In some embodiments of the method, the given cluster is associated with a respective cluster center. The distance is a distance between the cluster center of the given cluster and the given training example.

In some embodiments of the method, the similarity feature is at least two similarity features.

In some embodiments of the method, a number of similarity features amongst the at least two similarity features is equal to a total number of ground-truth classes.

In some embodiments of the method, the MLA is trained for performing binary classification of digital objects and wherein the total number of ground-truth classes is two.

In some embodiments of the method, the MLA is trained for performing multi-class classification of digital objects and wherein the total number of ground-truth classes is more than two.

In the context of the present specification, unless expressly provided otherwise, an “electronic device”, an “electronic device”, a “server”, a, “remote server”, and a “computer-based system” are any hardware and/or software appropriate to the relevant task at hand. Thus, some non-limiting examples of hardware and/or software include computers (servers, desktops, laptops, netbooks, etc.), smartphones, tablets, network equipment (routers, switches, gateways, etc.) and/or combination thereof.

In the context of the present specification, unless expressly provided otherwise, the expression “computer-readable medium” and “memory” are intended to include media of any nature and kind whatsoever, non-limiting examples of which include RAM, ROM, disks (CD-ROMs, DVDs, floppy disks, hard disk drives, etc.), USB keys, flash memory cards, solid state-drives, and tape drives.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a document could include the document itself (i.e. its contents), or it could be a unique document descriptor identifying a file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein. Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic illustration of a system as in accordance to at least some non-limiting embodiments of the present technology.

FIG. 2 depicts a representation of an ordered sequence of training examples generated by the system of FIG. 1, in accordance with at least some non-limiting embodiments of the present technology.

FIG. 3 depicts a representation of how a textual training feature and an embedding-based training feature are generated for a given training example by the server of FIG. 1, in accordance with at least some non-limiting embodiments of the present technology.

FIG. 4 depicts a representation of a single training iteration of a Machine Learning Algorithm (MLA) executed by the server of FIG. 1 based on a training dataset comprising the textual training feature and an embedding-based training feature, in accordance with at least some non-limiting embodiments of the present technology.

FIG. 5 depicts a representation of a single in-use iteration of the MLA of FIG. 4 based on an in-use dataset comprising a textual in-use feature and an in-use embedding-based feature, in accordance with at least some non-limiting embodiments of the present technology.

FIG. 6 is a block diagram representation of a method for determining the training dataset of FIG. 4 by the server of FIG. 1, as envisioned in at least some non-limiting embodiments of the present technology.

FIG. 7 is a block diagram representation of a method for determining the training dataset of FIG. 4 by the server of FIG. 1, as envisioned in at least some non-limiting embodiments of the present technology.

FIG. 8 depicts a representation how similarity training features are generated for a given training example by the server of FIG. 1, in accordance with at least some non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

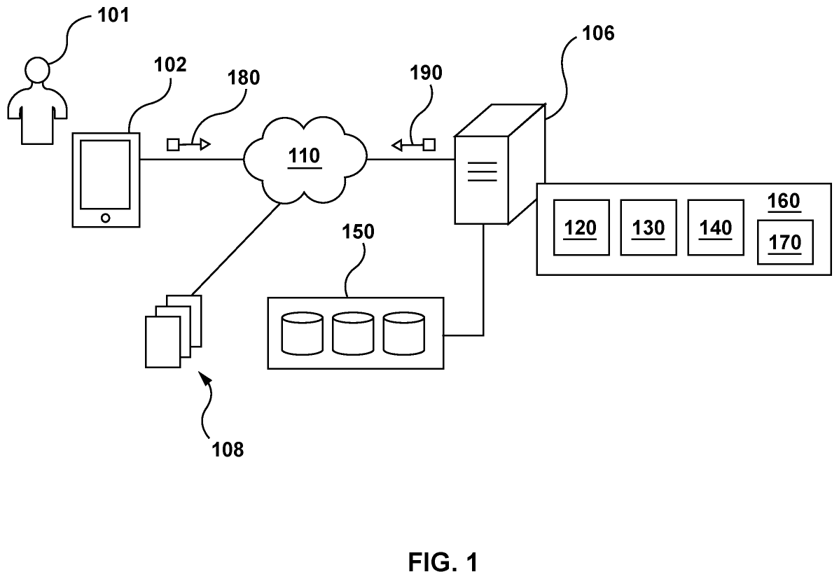

Referring to FIG. 1, there is shown a schematic diagram of a system 100, the system 100 being suitable for implementing non-limiting embodiments of the present technology. It is to be expressly understood that the system 100 as depicted is merely an illustrative implementation of the present technology. Thus, the description thereof that follows is intended to be only a description of illustrative examples of the present technology.

In the illustrated example, the system 100 may be employed for providing one or more online services to a given user. To that end, the system 100 comprises inter alia an electronic device 102 associated with the user 101, a server 106, a plurality of resource servers 108, and a database system 150.

In one non-limiting example, the system 100 may be employed to provide search engine services. In this example, the user 101 may submit a given query via the electronic device 102 to the server 106 which, in response, is configured to provide search results to the user 101. The server 106 generates these search results based on information that has been retrieved from, for example, the plurality of resource servers 108 and stored in the database system 150. These search results provided by the system 100 may be relevant to the submitted query. It can be said that the server 106 may be configured to host a search engine 120.

As it will become apparent from the description herein further below, in addition to (or instead of) providing the search engine services, other online services may be provided to the user 101 such as a content recommendation services, an email service, e-commerce, and the like. For example, the server 106 may be configured host one or more of a plurality of online services 160 comprising the search engine 120, an e-commerce platform 130, and an email platform 140.

In the context of the present technology, the system 100 providing one or more online services is configured to perform binary and/or multi-class classification of “digital objects” associated with the one or more online services. The nature of digital objects, and the purpose of its classification for different online services will be described in greater details herein further below.

### Electronic Device

As mentioned above, the system 100 comprises the electronic device 102 associated with the user 101. As such, the electronic device 102, or simply “device” 102 can sometimes be referred to as a “client device”, “end user device” or “client electronic device”. It should be noted that the fact that the electronic device 102 is associated with the user 101 does not need to suggest or imply any mode of operation—such as a need to log in, a need to be registered, or the like.

In the context of the present specification, unless provided expressly otherwise, “electronic device” or “device” is any computer hardware that is capable of running a software appropriate to the relevant task at hand. Thus, some non-limiting examples of the device 102 include personal computers (desktops, laptops, netbooks, etc.), smartphones, tablets and the like. The device 102 comprises hardware and/or software and/or firmware (or a combination thereof), as is known in the art, to execute a given browser application (not depicted).

Generally speaking, the purpose of the given browser application is to enable the user 101 to access one or more web resources. How the given browser application is implemented is not particularly limited. One example of the given browser application that is executable by the device 102 may be embodied in a Yandex™ browser. For example, the user 101 may use the given browser application to (i) navigate to a given search engine website, and (ii) submit a query in response to which (s)he is to be provided with relevant search results. In another example, the user 101 may use the given browser application to (i) navigate to an e-commerce website, and (ii) buy and/or sell a product or a service. In a further example, the user 101 may use the given browser application to (i) navigate to an email website, and (ii) access her email account for appreciating emails associated with her account.

The device 102 is configured to generate a request 180 for communicating with the server 106. The request 180 may take form of one or more data packets comprising information indicative of, in one example, the query submitted by the user 101. The device 102 is also configured to receive a response 190 from the server 106. The response 190 may take form of one or more data packets comprising information indicative of, in one example, search results that are relevant to the submitted query and computer-readable instructions for displaying by the given browser application to the user 101 these search results.

### Communication Network

The system 100 comprises a communication network 110. In one non-limiting example, the communication network 110 may be implemented as the Internet. In other non-limiting examples, the communication network 110 may be implemented differently, such as any wide-area communication network, local-area communication network, a private communication network and the like. In fact, how the communication network 110 is implemented is not limiting and will depend on inter alia how other components of the system 100 are implemented.

The purpose of the communication network 110 is to communicatively couple at least some of the components of the system 100 such as the device 102, the plurality of resource servers 108 and the server 106. For example, this means that the plurality of resource servers 108 is accessible via the communication network 110 by the device 102. In another example, this means that the plurality of resource servers 108 is accessible via the communication network 110 by the server 106. In a further example, this means that the server 106 is accessible via the communication network 110 by the device 102.

The communication network 110 may be used in order to transmit data packets amongst the device 102, the plurality of resource servers 108 and the server 106. For example, the communication network 110 may be used to transmit the request 180 from the device 102 to the server 106. In another example, the communication network 110 may be used to transmit the response 190 from the server 106 to the device 102.

### Plurality of Resource Servers

As mentioned above, the plurality of resource servers 108 can be accessed via the communication network 110. The plurality of resource servers 108 may be implemented as conventional computer servers. In a non-limiting example of an embodiment of the present technology, a given one of the plurality of resource servers 108 may be implemented as a Dell™ PowerEdge™ Server running the Microsoft™ Windows Server™ operating system. The given one of the plurality of resource servers 108 may also be implemented in any other suitable hardware and/or software and/or firmware or a combination thereof.

The plurality of resource servers 108 are configured to host (web) resources that can be accessed by the device 102 and/or by the server 106. Which type of resources the plurality of resource servers 108 is hosting is not limiting. However, in some embodiments of the present technology, the resources may comprise digital documents, or simply “documents”, that are representative of web pages.

For example, the plurality of resource servers 108 may host web pages, which means that the plurality of resource servers 108 may store documents representative of web pages and which are accessible by the device 102 and/or by the server 106. A given document may be written in a mark-up language and may comprise inter alia (i) content of a respective web page and (ii) computer-readable instructions for displaying the respective web page (content thereof).

A given one of the plurality of resource servers 108 may be accessed by the device 102 in order to retrieve a given document stored on the given one of the plurality of resource servers 108. For example, the user 101 may enter a web address associated with a given web page in the given browser application of the device 102 and, in response, the device 102 may access a given resource server hosting the given web page in order to retrieve the document representative of the given web page for rendering the content of the web page via the given browser application.

A given one of the plurality of resource servers 108 may be accessed by the server 106 in order to retrieve a given document stored on the given one of the plurality of resource servers 108. The purpose for the server 106 accessing and retrieving documents from the plurality of resource servers 108 will be described in greater detail herein further below.

### Database System

The server 106 is communicatively coupled to the database system 150. Generally speaking, the database system 150 is configured to acquire data from the server 106, store the data, and/or provide the data to the server 106 for further use.

In some embodiments, the database system 150 may be configured to store information associated with the one or more online services hosted by the server 106. For example, in a case where the server 106 hosts the search engine 120, the database system 150 may store information about previously performed searches by the search engine 120, information about previously submitted queries to the server 106, and about documents that have been provided by the search engine 120 of the server 106 as search results.

In this example, it is contemplated that the database system 150 may store query data associated with respective queries submitted to the search engine 120. Query data associated with a given query may be of different types and is not limiting. For example, the database system 150 may store query data for respective queries such as, but not limited to:
popularity of a given query;
frequency of submission of the given query;
number of clicks associated with the given query;
indications of other submitted queries associated with the given query;
indications of documents associated with the given query;
other statistical data associated with the given query;
search terms associated with the given query;
number of characters within the given query; and
other query-intrinsic characteristics of the given query.

In this example, the database system 150 may also store document data associated with respective documents. Document data associated with a given document may be of different types and is not limiting. For example, the database system 150 may store document data for respective documents such as, but not limited to:
popularity of a given document;
click-through-rate for the given document;
time-per-click associated with the given document;
indications of queries associated with the given document;
other statistical data associated with the given document;
text associated with the given document;
file size of the given document; and
other document-intrinsic characteristics of the given document.

In this example, the database system 150 may also store user data associated with respective users. User data associated with a given user may be of different types and is not limiting. For example, the database system 150 may store user data for respective users such as, but not limited to:
web session data;
submitted query data;
“click” history;
interaction data; and
user preferences.

In at least some embodiments of the present technology, it is contemplated that the database system 150 may be configured to store data associated with a given “entity” or “object” of a given online service. It can be said that the database system 150 may be configured to store “object-specific” data. It is contemplated that the server 106 may be configured to store data about various objects of a given online service on an object-specific basis, without departing from the scope of the present technology.

For example, in the case of the server 106 hosting the search engine 120, the database system 150 may be configured to store data associated with respective users thereof (first type of digital objects or entities associated with the server engine services). Therefore, in this example, the database system 150 may be configured to store user-specific data on a user-by-user basis. In another example, in the case of the server 106 hosting the search engine 120, the database system 150 may be configured to store data associated with respective digital documents that have been used as search results (second type of digital objects or entities associated with the server engine services). Therefore, in this example, the database system 150 may be configured to store document-specific data on a document-by-document basis.

In a further example, in the case of the server 106 hosting the email platform 140, the database system 150 may be configured to store data associated with respective users thereof (first type of digital objects or entities associated with the email service). Therefore, in this example, the database system 150 may be configured to store user-specific data on a user-by-user basis. In another example, in the case of the server 106 hosting the email platform 140, the database system 150 may be configured to store data associated with respective emails (second type of digital objects or entities associated with the email service). Therefore, in this example, the database system 150 may be configured to store email-specific data on an email-by-email basis.

Hence, it can be said that the database system 150 may be configured to store different object-specific data depending on inter alia types of online service(s) hosted by the server 106, and types of objects associated with those online service(s).

As it will become apparent from the description herein further below, the server 106 is configured to execute a classification model 170 that is configured to perform binary and/or multi-class classification of digital objects from one or more online services provided by the server 106.

In at least some embodiments of the present technology, the database system 150 may be configured to store “labelled” object-specific data. For example, labelled object-specific data for a given digital object may include label data indicative of “ground-truth” class of the given digital object. How label data is collected and/or generated and then stored in the database system 150 is not particularly limiting. In some cases, label data may be collected from human assessors that have been tasked with “labelling” respective objects.

It should be noted that object-specific data stored for respective digital object may comprise inter alia textual data, embedding-based data, categorical data, and the like. For example, textual data stored in association with a respective document may be representative of text included in the respective document.

Embedding-based data stored in association with a respective document may comprise one or more “embeddings” generated for the respective document. Broadly speaking, an “embedding” is the collective name for a set of language modelling and feature learning techniques in natural language processing where words or phrases from the vocabulary are mapped to vectors of real numbers. Conceptually, this operation involves a mathematical embedding from a space with many dimensions per word to a continuous vector space with a much lower dimension. Embeddings make it easier to do machine learning on large inputs like sparse vectors representing words, for example. In some embodiments, it can be said that one or more embeddings stored for a given document may be generated based on words (e.g., textual data) associated with the given document. In one example, an embedding captures some of the semantics of the input by placing semantically similar inputs close together in the embedding space. It is also contemplated that embeddings can be learned and reused across models.

The server 106 could be configured to generate embedding-based data in different ways.

In one example, the server 106 may make use of an “embedding layer” of a Neural Network (NN) for generating one or more embeddings. In another example, the server 106 may make use of a “Word2Vec” algorithm as known in the art for efficiently learning word embeddings from a text corpus. In a further example, the server 106 may make use of a “GloVe” algorithm that combines the global statistics of matrix factorization techniques with the local context-based learning used in word2vec techniques. In some embodiments, the server 106 may make use of a “fastText” library for learning word embeddings. In other embodiments, the server 106 may make use of a deep Neural Network trained on ImageNet dataset, for example, for generating image-based embeddings.

It should be noted that object-specific data may be used for generating training datasets for training the classification model 170. More particularly, the object-specific data may be used by the server 106 for generating training features to be used for training the classification model 170. It should also be noted that object-specific data may be used for generating in-use datasets for the classification model 170. More particularly, the object-specific data may be used by the server 106 for generating in-use features to be used by the classification model 170 for performing classification of a respective in-us object.

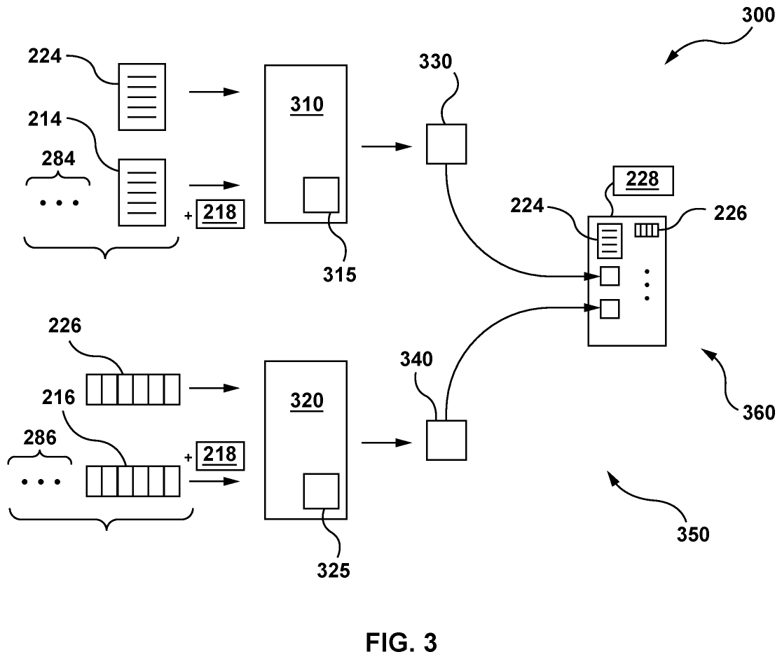

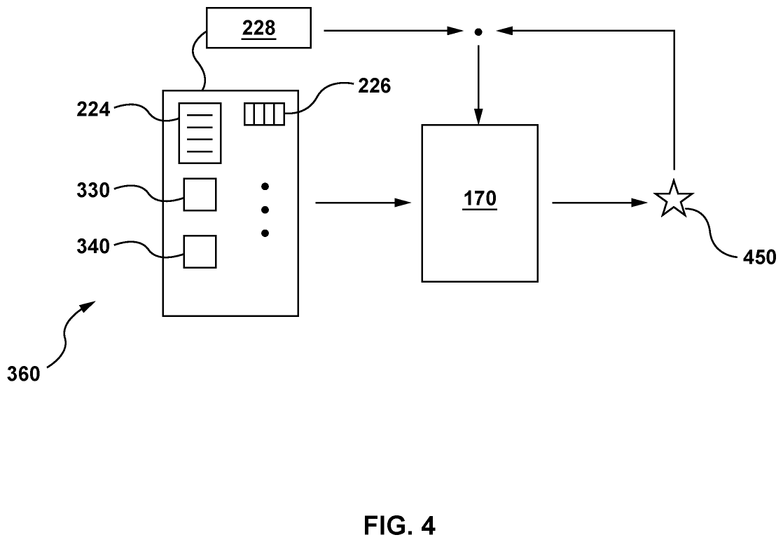

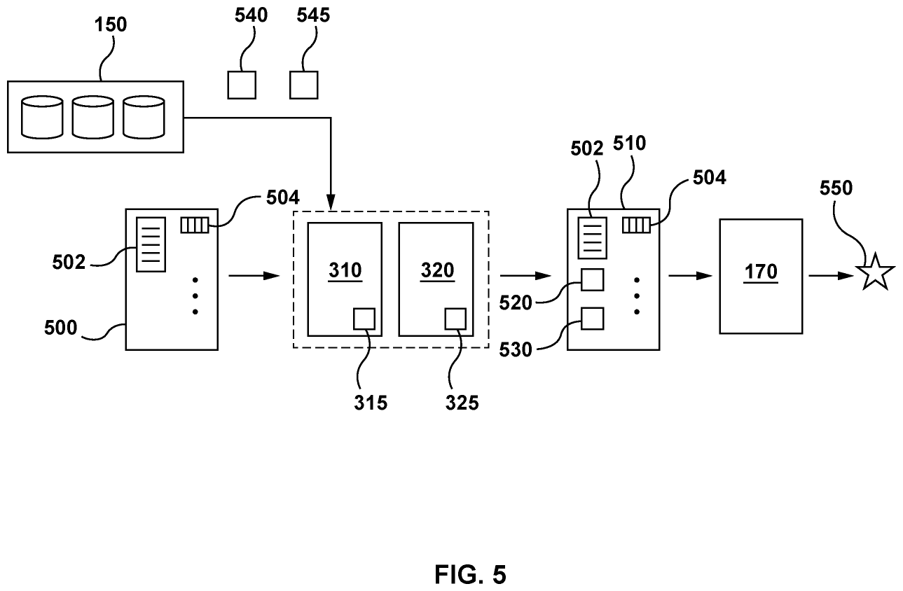

How object-specific data may be used by the server 106 during training of the classification model 170 will be discussed herein further below with reference to FIGS. 3 and 4, while how object-specific data may be used by the server 106 during in-use phase of the classification model 170 will be discussed herein further below with reference to FIG. 5.

### Server

The system 100 comprises the server 106 that may be implemented as a conventional computer server. In an example of an embodiment of the present technology, the server 106 may be implemented as a Dell™ PowerEdge™ Server running the Microsoft™ Windows Server™ operating system. Needless to say, the server 106 may be implemented in any other suitable hardware and/or software and/or firmware or a combination thereof. In the depicted non-limiting embodiment of present technology, the server 106 is a single server. In alternative non-limiting embodiments of the present technology, the functionality of the server 106 may be distributed and may be implemented via multiple servers.

As illustrated on FIG. 1, the server 106 can be configured to host the plurality of online services 160. For example, the server 106 may host the search engine 120 for providing search engine services, an e-commerce platform 130 for providing e-commerce services, and an email platform 140 for providing email services. How the search engine 120, the e-commerce platform 130, and the email platform 140 may be implemented in at least some embodiments of the present technology will now be described.

In some embodiments, the server 106 may be under control and/or management of a search engine provider (not depicted) such as, for example, an operator of the Yandex' search engine. As such, the server 106 may be configured to host the search engine 120 for performing one or more searches responsive to queries submitted by users of the search engine 120.

For example, the server 106 may receive the request 180 from device 102 indicative of the query submitted by the user 101. The server 106 may perform a search responsive to the submitted query for generating search results that are relevant to the submitted query. As a result, the server 106 may be configured to generate the response 190 indicative of the search results and may transmit the response 190 to the device 102 for display of the search results to the user 101 via the given browser application, for example.

The search results generated for the submitted query may take many forms. However, in one non-limiting example of the present technology, the search results generated by the server 106 may be indicative of documents that are relevant to the submitted query. How the server 106 is configured to determine and retrieve documents that are relevant to the submitted query will become apparent from the description herein.

The server 106 may also configured to execute a crawler application (not depicted). Broadly speaking, the crawler application may be used by the server 106 in order to “visit” resources accessible via the communication network 110 and to retrieve/download them for further use. For example, the crawler application may be used by the server 106 in order to access the plurality of resource servers 108 and to retrieve/download documents representative of web pages hosted by the plurality of resource servers 108.

It is contemplated that the crawler application may be periodically executable by the server 106 in order to retrieve/download documents that have been updated and/or became accessible over the communication network 110 since a previous execution of the crawler application.

In other embodiments, the server 106 may be under control and/or management of a e-market provider (not depicted) such as, for example, an operator of the Yandex.Market' e-commerce platform. As such, the server 106 may be configured to host the e-commerce platform 130 for offering one or more articles and/or services for purchase or sale by users of the e-commerce platform 130.

Generally speaking, the e-commerce platform refers to one or more computer-implemented algorithms that enable the server 106 to provide e-commerce services for the user 101 of the electronic device 102. For example, the user 101 may be a customer of the e-commerce platform 130. The user 101 may enter a URL associated with the e-commerce platform 130 in the command interface of the browser application and may access her account with the e-commerce platform 130.

It should be noted that the server 106 may be configured to collect information regarding the customers and products available on the e-commerce platform 130. In one example, the server 106 may be configured to collect customer-specific information regarding customer interactions with different products. In this example, the server 106 may collect for a given customer information regarding viewed products, clicked products, purchased products, recommended products, and the like. In another example, the server 106 may be configured to collect product-specific information regarding different products. In this example, the server 106 may be configured to collect for a given product information regarding views, clicks, purchases, purchasers, and the like.

In some embodiments, it is contemplated that the server 106 may be configured to collect textual data associated with customers and products of the e-commerce platform 130. For example, textual data associated with a given customer may include one or more reviews of the customer regarding purchased products. In another example, textual data associated with a given product may include the product's description and/or one or more reviews of the product by customers of the e-commerce platform 130.

In further embodiments, the server 106 may be under control and/or management of a email service provider (not depicted) such as, for example, an operator of the Yandex.Mail' email service. As such, the server 106 may be configured to host the email platform 140 for providing email services to users of the email platform 140.

Generally speaking, the email platform 140 refers to one or more computer-implemented algorithms that enable the server 106 to provide email services for the user 101 of the electronic device 102. For example, the user 101 may have an email account associated with the email platform 140. The user 101 may enter a URL associated with the email platform 140 in the command interface of the browser application and may access her email account with the email platform 140.

In some embodiments of the present technology in addition to, or instead of, the electronic device 104 may be configured to execute a device-side email application (not depicted) associated with the (server-side) platform 140. Broadly speaking, the purpose of the device-side email application is to enable the user 101 to: browse a list of emails (both unread and read), read emails, open attachments, compose new emails, reply to emails, forward emails, delete emails, manage junk emails, assign categories to emails, organize emails into folders, create and access an address book and the like.

Irrespective of whether the user 101 makes use of the browsing application and/or the device-side email application for accessing her email account, it is contemplated that the user 101 may be provided with an email interface (not depicted) for performing one or more actions on emails in her email account. The functionality of the email platform 140 will be described in greater details herein further below.

Generally speaking, the purpose of the email interface is to allow user interactivity between a given user of the platform 140 (such as the user 101, for example) and emails in her email account. In one non-limiting example, the email interface may comprise one or more bars, one or more menus, one or more buttons, and may also enable other functionalities for allowing user interactivity with emails. It should be noted that a variety of email interfaces may be envisioned in the context of the present technology.

For example, the email interface may comprise a side bar indicative of one or more email folders (pre-determined and/or personalized) associated with a given email account such as, but not limited to: “inbox” folder, “outbox” folder, “drafts” folder, “junk” or “spam” folder, “deleted” folder, and the like. In another example, the email interface may comprise one or more buttons for performing various actions on emails such as, but not limited to: a “compose” button for composing a new email, a “send” button for sending a given email, a “save” button for saving a current version of a given email, a “read” button for indicating that a given email has been read or viewed by a given user, a “unread” button for indicating that a given email is unread or unviewed by a given user, a “spam” or “junk” button for indicating that a given email is to be categorized as a spam email and/or for indicating that the given email is to be transferred/moved to the “spam” folder, a “deleted” button for indicating that a given email is to be deleted and/or that the given email is to be transferred/moved to the “deleted” folder, and the like. In yet another example, the email interface may allow for other types of user interactivity with emails such as, but not limited to, “drag and drop” functionality for a given user to be able to select a given email from a first folder and to transfer/move the given email into a second folder in a seamless manner.

In some embodiments, it is contemplated that the server 106 may be configured to collect textual data associated with emails of the email platform 130. For example, textual data associated with email may include the body of an email. It should be noted that textual data associated with emails may be classified into different classes such as, body text, attachment text, signature text, and the like. In at least some embodiments, it is contemplated that textual data associated with emails of the email platform 130 may be anonymized, without departing from the scope of the present technology.

In the context of the present technology, the server 106 is configured to execute the classification model 170. Broadly speaking, the classification model 170 is configured to use data stored in association with a digital object of a given online service and perform binary and/or multi-class classification of that digital object. How the server 106 is configured to generate training datasets (such as a training dataset 360 illustrated in FIGS. 3 and 4) and train the classification model 170, and how the server 106 is configured to use the classification model 170 during its in-use phase will now be discussed in turn.

In some embodiments of the present technology, the server 106 may retrieve “training examples” from the database system 150, each comprising object-specific data and a label associated with a respective digital object.

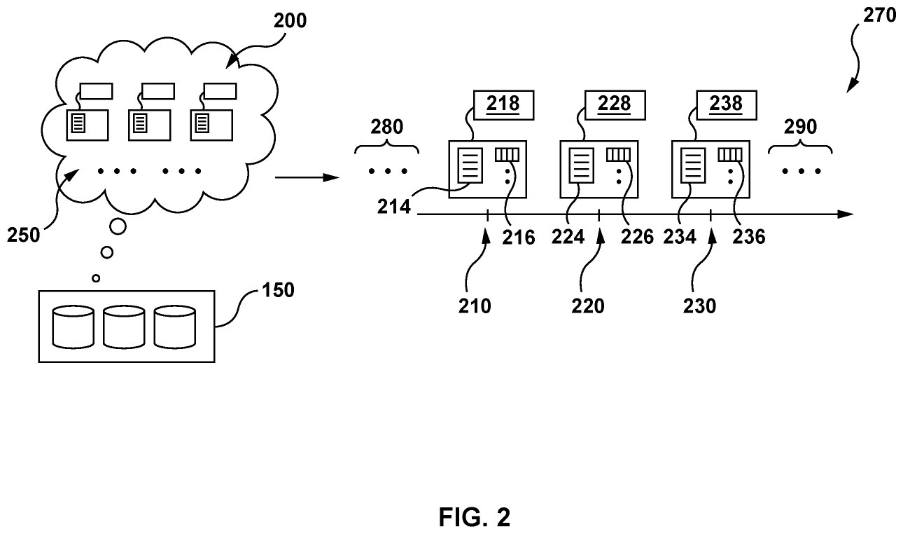

With reference to FIG. 2, there is depicted a representation 200 of object-specific data stored in the database system 150. Broadly speaking, the object-specific data may be associated with respective digital objects and can be said to represent a plurality of training “examples” 250 to be used for training purposes. It can be said that a given training example corresponds to a respective digital object to be used for training the classification model 170.

The server 106 is configured to acquire the plurality of training examples 250 from the database system 150 and order the plurality of training examples 250 into an ordered sequence of training examples 270. As illustrated, the server 106 orders the plurality of training examples 250 into the ordered sequence 270 that includes: (i) a sub-sequence of training examples 280, (ii) training examples 210, 220, and 230, and (iii) a sub-sequence of training examples 290, in that order.

It can be said that a given training example comprises textual data associated with a respective object, embedding-based data associated with a respective object and an indication of a ground-truth class of the respective object. In at least some embodiments of the present technology, it is contemplated that a given training example may comprise at least one of (i) textual data associated with a respective object and (ii) embedding-based data associated with a respective object.

For sake of simplicity only, let it be assumed that a training example comprises textual data associated with a respective document, embedding-based data associated with a respective document and an indication of a ground-truth class of the respective document. However the nature of the digital objects associated with the plurality of training examples 250 depends on inter alia different implementations of the present technology.

For example, as it can be seen on FIG. 2:
the training example 210 comprises textual data 214 associated with a first document, embedding-based data 216 (e.g., one or more embeddings) associated with the first document, and a label 218 indicative of a ground-truth class of the first document;
the training example 220 comprises textual data 224 associated with a second document, embedding-based data 226 (e.g., one or more embeddings) associated with the second document, and a label 228 indicative of a ground-truth class of the second document; and
the training example 230 comprises textual data 234 associated with a third document, embedding-based data 236 (e.g., one or more embeddings) associated with the third document, and a label 228 indicative of a ground-truth class of the third document.

It is contemplated that training examples in the sub-sequence of training examples 280 and in the sub-sequence of training examples 290 may be implemented similarly to how the training examples 210, 220 and 230 are implemented. In some embodiments, a given training example may include additional data about respective digital documents, such as different document-specific features, categorical features, and the like, to the data that is non-exhaustively listed above.

As mentioned above, the server 106 is configured to order the plurality of training examples 250 into the ordered sequence of training examples 270. In some embodiments, the server 106 may be configured to randomly order the plurality of training examples 250—that is, the ordered sequence of training examples 270 may be a randomly-determined order of training examples. In other embodiments, the server 106 may be configured to order the plurality of training examples 250 based on one or more “object-inherent” characteristic associated with the respective objects. For example, the server 106 may be configured to use the creation date of respective digital documents for ordering the plurality of training examples 250. As such, the ordered sequence of training examples 270 may be a sequence of training examples ordered from the “most old” digital document to the “most fresh” digital document, or vice versa depending on inter alia a specific implementation of the present technology.

It is contemplated that the server 106 may be configured to assign a positional indicator to each training example in the ordered sequence of training examples 270 for identifying which training examples precede a given training example and which training examples follow the given training example. For example, the server 106 may use such position indicators for determining that, in the ordered sequence of training examples 270, training examples from the sub-sequence of training examples 180 and the training example 210 are previous training examples to the training example 220, whereas as the training example 230 and the sub-sequence of training examples 290 are subsequent (or following) training examples to the training example 220.

It should be noted that the server 106 may make use of such positional information regarding respective training examples in the ordered sequence of training examples 270 when generating training features for respective training examples.

With reference to FIG. 3, there is depicted a representation 300 (at the top thereof) of how the server 106 is configured to generate a textual training feature 330 for the training example 220, and a representation 350 (at the bottom thereof) of how the server is configured to generate an embedding-based training feature 340 for the training example 220.

It can be said that the server 106 is configured to execute one or more computer-implemented algorithms that are herein referred to as a “textual feature generator” 310. Broadly speaking, the textual feature generator 310 is configured to generate a textual training feature for a given training example from the ordered sequence of training examples 270 based on textual data associated with a particular sub-sequence of training examples from the ordered sequence of training examples 270 and a textual-analysis function 315. As it will become apparent from the description herein further below, it should be noted that the textual feature generator 310 may also be used during the in-use phase of the classification model 170 for generating textual in-use features for respective in-use examples, without departing from the scope of the present technology.

For generating the training dataset 360 for the training example 220, as seen on FIG. 3, the server 106 is configured to determine which training examples from the ordered sequence of training examples 270 are previous training examples to the training example 220. For example, based on the positional information in the ordered sequence, the server 106 may determine that the sub-sequence of training examples 280 and the training example 210 are previous training examples to the training example 220.

The server 106 may be configured to provide the textual data 224 associated with the training example 220, the textual data associated with the respective previous training examples (textual data 284 associated with training examples from the sub-sequence of training examples 280 and the textual data 214 from the training example 210), and the labels associated with the respective previous training examples (the labels associated with training examples from the sub-sequence of training examples 280 and the label 218 for the training example 210) to the textual feature generator 310.

It is also contemplated that, for generating the training dataset 360 for the training example 220, the server 106 may also be configured to determine which training examples from the ordered sequence of training examples 270 are subsequent training examples to the training example 220. It can be said that the server 106 may also be configured to exclude the textual data associated with the subsequent training examples from the generation process of the textual training feature 330.

As illustrated, the textual feature generator 310 comprises a textual-analysis function 315. Broadly speaking, the textual-analysis function 315 is a computer-implemented function that is configured to perform an information retrieval operation on a textual dataset. In some embodiments, the textual-analysis function 315 may be configured to compute one or more statistical features on the textual dataset. For example, the textual-analysis function 315 may be configured to compute one or more statistical features for the textual data 224 associated with the training example 220, and one or more statistical features for the textual data associated with the respective previous training examples. It is contemplated that the server 106 may be configured to generate the textual training feature 330 as a combination of one or more statistical features for the textual data 224 and the one or more statistical features for the textual data associated with the respective previous training examples.

It should be noted that the textual-analysis function 315 may be tailored by an operator of the server 106 for computing one or more pre-determined types of statistical features based on textual data. In some embodiments, it is contemplated that the textual-analysis function 315 may be configured to compute one or more pre-determined types of statistical features based on textual data such that, when the one or more pre-determined types of statistical features for the textual data 224 and the one or more pre-determined types of statistical features for the textual data associated with the respective previous training examples are combined by the server 106, the resulting textual training feature 330 is at least one of, but not limited to: a Naïve Bayes type (e.g., probabilities of K classes given sample's text), TF-IDF type (e.g., term frequency—inverse document frequency), BM25 type (e.g., scores for each of K classes where D is for set of texts from previous training examples, and Q is for text of given training example).

It is contemplated that the one or more pre-determined types of statistical features computed based the textual data associated with the respective previous training examples may be class-specific statistical features. For example, the statistical features computed based the textual data associated with the respective previous training examples may comprise: (i) a first statistical feature computed based on textual data associated with a first subset of previous training examples belonging to a first class (indicated by respective labels), and (ii) a second statistical feature computed based on textual data associated with a second subset of previous training examples belonging to a second class (indicated by respective labels).

It is contemplated that the server 106 may be configured to cluster previous training examples based on their respective labels, such that previous training examples of a same ground-truth class are part of a same cluster. Once the previous training examples are so-clustered into at least two clusters, the server 106 may be configured to determine a first class-specific feature based on the textual data 224 and the textual data of the previous training examples belonging to a first cluster. The server 106 may also determine a second class-specific feature based on the textual data 224 and the textual data of the previous training examples belonging to a second cluster.

It is contemplated that a textual feature may be a numerical value generated by the server 106 based on the textual data of a given training example and the textual data and labels of respectively previous training examples. In some embodiments, a given class-specific textual feature may be indicative of a similarity between the textual data in the given training example and the textual data in previous training examples that are of a given class.

It should be noted that, irrespective of a specific implementation of the textual-analysis function 315 and the specific pre-determined types of statistical features computed based on textual data, the textual training feature 330 is generated based on the textual data associated with the respective training example 220 and the textual data and label data associated with the respective previous training examples in the ordered sequence of training examples 270, and without taking into account the textual training data associated with the respective subsequent training examples in the ordered sequence of training examples.

It can be said that the server 106 is configured to generate a given textual training feature based on a respective training example by “looking back” at previous examples in the ordered sequence and without “looking ahead” at subsequent examples in the ordered sequence. Without wishing to be bound to any specific theory, developers of the present technology have realized that so-generating textual training features for respective training datasets for training the classification model 170 may allow reducing the risk and/or impact of over-training on the prediction quality of the classification model 170 during an in-use phase thereof.

As illustrated in FIG. 3, the server 106 is configured to execute one or more computer-implemented algorithms that are herein referred to as an “embedding-based feature generator” 320. Broadly speaking, the embedding-based feature generator 320 is configured to generate an embedding-based feature for a given training example from the ordered sequence of training examples 270 based on (i) embedding-based data associated with a particular sub-sequence of training examples from the ordered sequence of training examples 270 and (ii) an embedding-analysis function 325.

For generating the training dataset 360 for the training example 220, as seen in FIG. 3, the server 106 is configured to determine which training examples from the ordered sequence of training examples 270 are previous training examples to the training example 220. For example, based on the position information in the ordered sequence, the server 106 may determine that the sub-sequence of training examples 280 and the training example 210 are previous training examples to the training example 220.

The server 106 may be configured to provide the embedding-based data 226 associated with the training example 220, embedding-based data associated with the previous training examples (embedding-based data 286 associated with training examples from the sub-sequence of training examples 280 and the embedding-based data 216 from the training example 210) and labels associated with the respective previous training examples (the labels associated with training examples from the sub-sequence of training examples 280 and the label 218 for the training example 210) to the embedding-based feature generator 320.

It is also contemplated that, for generating the training dataset 360 for the training example 220, the server 106 may be configured to determine which training examples from the ordered sequence of training examples 270 are subsequent training examples to the training example 220. It can be said that the server 106 may also be configured to exclude the embedding-based data associated with the subsequent training examples from the generation process of the embedding-based training feature 340.

As illustrated, the embedding-based feature generator 320 comprises an embedding-analysis function 325. Broadly speaking, the embedding-analysis function 325 is a computer-implemented function that is configured to perform an information retrieval operation on an embedding-based dataset (e.g., a plurality of embeddings). For example, the embedding-analysis function 325 may be configured to compute one or more statistical features for the embedding-based data 226 associated with the training example 220, and one or more statistical features for the embedding-based data associated with the respective previous training examples. It is contemplated that the server 106 may be configured to generate the embedding-based training feature 340 as a combination of one or more statistical features for the embedding-based data 226 and the one or more statistical features for the embedding-based data associated with the respective previous training examples.

It should be noted that the embedding-analysis function 325 may be tailored by the operator of the server 106 for computing one or more pre-determined types of statistical features based on embedding-based data. In some embodiments, it is contemplated that the embedding-analysis function 325 may be configured to compute one or more pre-determined types of statistical features based on embedding-based data such that, when the one or more pre-determined types of statistical features for the embedding-based data 226 and the one or more pre-determined types of statistical features for the embedding-based data associated with the respective previous training examples are combined by the server 106, the resulting embedding-based training feature 340 is at least one of, but not limited to: distance between a given embedding for the training example 220 and a cluster-center computed for embeddings from the previous training examples that are of a same class as the training example, and distance between the given embedding for the training example 220 and an other cluster-center computed for embeddings from the previous training examples that are of a different class than the training example 220.

It should be noted that the server 106 employing the embedding-analysis function 325 may be configured to determine a variety of embedding-based similarity features. For example, it is contemplated that the server 106 may be configured to determine an embedding-based similarity feature that is indicative of at least one of: (i) a cosine or L2 distance of sample's embedding to an average embedding of a particular class, L2 distance to the nearest or k-th nearest neighbor from a particular class, a linear discriminant analysis value, and the like.

It is contemplated that the server 106 may be configured to cluster previous training examples based on their respective labels, such that previous training examples of a same ground-truth class are part of a same cluster. Once the previous training examples are so-clustered into at least two clusters, the server 106 may be configured to determine a first class-specific feature based on the embedding-based data 226 and the embedding-based data of the previous training examples belonging to a first cluster. The server 106 may also determine a second class-specific feature based on the embedding-based data 226 and the embedding-based data of the previous training examples belonging to a second cluster.

It is contemplated an embedding-based feature may be a numerical value generated by the server 106 based on the embedding-based data of a given training example and the embedding-based data and labels of respectively previous training examples. In some embodiments, a given class-specific embedding-based feature may be indicative of a similarity between the embedding-based data in the given training example and the embedding-based data in previous training examples that are of a given class.

It should be noted that, irrespective of a specific implementation of the embedding-analysis function 325 and the specific pre-determined types of statistical features computed based on embedding-based data, the embedding-based training feature 340 is generated based on the embedding-based data associated with the respective training example 220 and the embedding-based data associated with the respective previous training examples in the ordered sequence of training examples 270, and without taking into account the embedding-based training data associated with the respective subsequent training examples in the ordered sequence of training examples.

It can be said that the server 106 is configured to generate a given embedding-based training feature based on a respective training example by “looking back” at previous examples in the ordered sequence and without “looking ahead” at subsequent examples in the ordered sequence. Without wishing to be bound to any specific theory, developers of the present technology have realized that so-generating embedding-based training features for respective training datasets for training the classification model 170 may allow reducing the risk and/or impact of over-training on the prediction quality of the classification model 170 during an in-use phase thereof.

It should be noted that the server 106 may be configured to generate textual and/or embedding-based features for other ones from the ordered sequence of training examples 270 in a similar manner to how the server 106 is configured to generate the textual training feature 330 and/or the embedding-based training feature 340 for the training example 220.

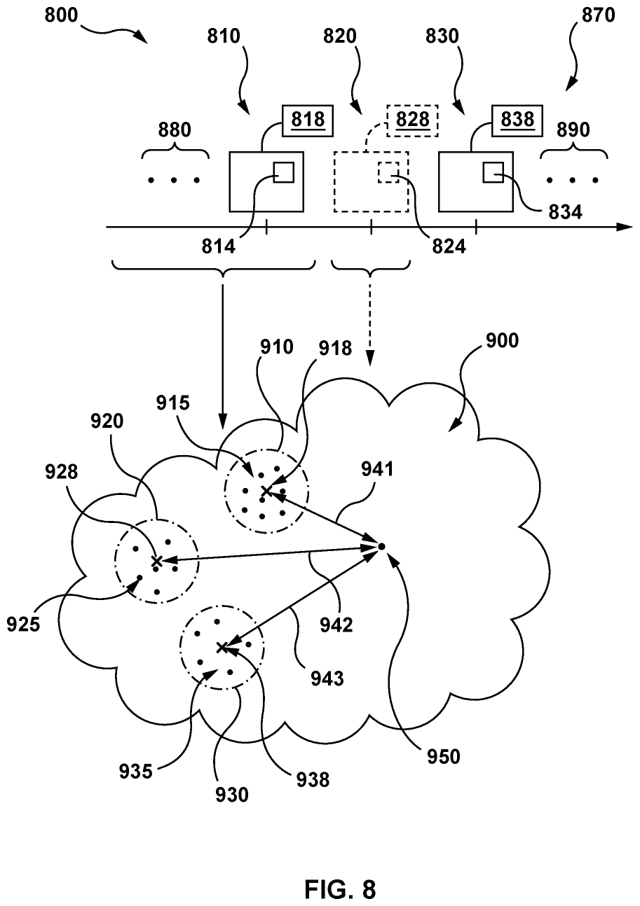

In at least some embodiments of the present technology, it can be said that the server 106 may be configured to generate one or more “similarity features” for a given training example. With reference to FIG. 8, there is depicted a representation 800 of how the server 106 is configured to generate a number of similarity features for a given digital object.

The server 106 may be configured to generate an ordered sequence of training examples 870 comprising a sub-sequence 880, training example 810, training example 820, training example 830, and a sub-sequence 890, in that order. The server 106 may be configured to generate the ordered sequence of training examples 870 similarly to how the server 106 is configured to generate the ordered sequence of training examples 270.

It should be noted that (i) the training example 810 comprises object-specific data 814 associated with a respective digital object and a label 818 indicative of a ground-truth class of the respective digital object, (ii) the training example 820 comprises object-specific data 824 associated with a respective digital object and a label 828 indicative of a ground-truth class of the respective digital object, and (iii) the training example 830 comprises object-specific data 834 associated with a respective digital object and a label 838 indicative of a ground-truth class of the respective digital object.

In some embodiments, object-specific data in a given training example from the ordered sequence of training examples 870 may comprise textual data. In other embodiments, object-specific data in a given training example from the ordered sequence of training examples 870 may comprise embedding-based data. In further embodiments, object-specific data in a given training example from the ordered sequence of training examples 870 may comprise one or more embeddings generated for the given training example based on textual data associated with the given object, image data associated with the given object, and the like, and may depend on inter alia a specific implementation of the present technology. It is contemplated that the object-specific data in a given training example may comprise one or more vectors representative of a set of pre-determined object-specific features that have been previously stored in the database system 150.

In yes further embodiments, object-specific data in a given training example from the ordered sequence of training examples 870 may comprise photos or any other digital objects that can be said to be associated with a “distance feature”, i.e. capable of being analyzed for similarity based on proximity in a virtual space, once projected therein.

The server 106 may be configured to generate a number of similarity features for the digital object associated with the training example 828. The server 106 may be configured to cluster the respectively previous training examples into at least two clusters of previous training examples.

As seen in FIG. 8, the server 106 may be configured to use object-specific data associated with the respectively previous training examples (the training example 810 and the sub-sequence of training examples 880) for mapping the respectively previous training examples in a multidimensional space 900 executed by the server 106. How the multidimensional space 900 is implemented by the server 106 is not particularly limiting. However, it should be noted that the multidimensional space 900 may be based on types of data in the object-specific data and inter alia specific implementations of the present technology.

The server 106 may be configured to use one or more clustering algorithms as known in the art in order to cluster the respectively previous training examples into a first cluster 910, a second cluster 920, and a third cluster 930. It should be noted that a number of resulting clusters after the clustering procedure may be pre-determined based on a total number of ground-truth classes associated with training examples. In the illustrated example, the ground-truth classes may include three classes (e.g., multi-class classification), however in other embodiments, there could be more than three classes, or there could be two classes (e.g., binary classification).

It should be noted that the first cluster 910 comprises a first subset of previous training examples 915 from the previous training examples which are of a first ground-truth class, the second cluster 920 comprises a second subset of previous training examples 925 from the previous training examples which are of a second ground-truth class, and the third cluster 930 comprises a third subset of previous training examples 935 from the previous training examples which are of a third ground-truth class.

In some embodiments of the present technology, the server 106 may be configured to determine cluster centers of respective clusters in the multidimensional space 900. For example, the server 106 may be configured to determine a first cluster center 918 for the first cluster 910 associated with the first ground-truth class, a second cluster center 928 for the second cluster 920 associated with the second ground-truth class, and a third cluster center 938 for the third cluster 910 associated with the third ground-truth class.

The server 106 may be configured to use object-specific data associated with the training example 820 for mapping the training example 820 in the multidimensional space 900. For example, the server 106 may map the training example 820 to a location 950 in the multidimensional space 900.

The server 106 may be configured to generate a given similarity feature for the training example 820 based on a given distance between the training example 850 and a respective cluster. For example, the server 106 may be configured to determine a first distance 941 between the first cluster center 918 and the location 950, a second distance 942 between the second cluster center 928 and the location 950, and a third distance 943 between the third cluster center 938 and the location 950.

The type of distance(s) being determined by the server 106 in the multidimensional space 900 depends on inter alia different implementations of the present technology. In some embodiments, the server 106 may be configured to determine Euclidean distances.

The server 106 may be configured to generate three respective similarity features based on the first distance 941, the second distance 942, and the third distance 943. It should be noted that the first distance 941 is indicative of a similarity between the training example 820 and the previous training examples of the first ground-truth class (the first subset of training examples 915), the first distance 942 is indicative of a similarity between the training example 820 and the previous training examples of the second ground-truth class (the second subset of training examples 925), and the third distance 943 is indicative of a similarity between the training example 820 and the previous training examples of the third ground-truth class (the third subset of training examples 935). Hence it can be said that a given similarity feature is indicative of similarity between a given training example and previous training examples of a given class.

The server 106 may be configured to employ so-determined similarity features for generating a respective training set for the training example 820. In this case, three similarity features may be included in a training input of the respective training set for training the classification model 170.

As previously alluded to, the server 106 is configured to employ one or more MLAs for supporting a variety of search engine services. In at least some embodiments of the present technology, the server 106 is configured to execute a decision-tree based MLA for implementing the classification model 170.

In the context of the present technology, the decision-tree based MLA may be trained to determine, during in-use, a prediction value for a given in-use dataset which is one of a discrete set of prediction values. For example, the classification model 170 may be trained to determine, during in-use for a given document, whether the given document is a news article or a scientific article. For that reason, the decision-tree based MLA may be embodied as a “classification” tree MLA, as opposed to a “regression” tree MLA, since they are trained to perform a classification task on a given object. Needless to say, the server 106 may use object classification solutions in many ways for providing better online services to the user 102.

As such, the classification model 170 is first “built” (or trained) using a training dataset comprising training objects and respective target values (labels). Since the classification model 170 is trained for performing a classification task, a given label for a given training object may be indicative of a ground-truth class associated with the given training object.

To summarize, the implementation of the classification model 170 by the server 106 can be broadly categorized into two phases—a training phase and an in-use phase. First, the classification model 170 is trained during the training phase. Then, once the classification model 170 is built based on training data, the classification model 170 is actually employed by the server 106 using in-use data during the in-use phase. How the classification model 170 may be trained based on a given training dataset and used during its in-use phase will now be described in turn.

The server 106 is configured to train the classification model 170 based on training datasets, comprising inter alia the training dataset 360 generated for the training example 220.

With reference to FIG. 4, there is depicted a single training iteration of the classification model 170 based on the training dataset 360.

The server 106 is configured to provide the training dataset 360 to the classification model 170. For example, the server 106 may be configured to input the textual data 224, the embedding-based data 226, as well as the textual training feature 330 and the embedding-based training feature 340, into the classification model 170 for making a class prediction. As such, the classification model 170 is configured to output a prediction value 450 indicative of a predicted class of the document associated with the training dataset 360.

The server 106 is configured to compare the label 228 indicative of the ground-truth class of the document associated with the training dataset 360 against the prediction value 450 indicative of the predicted class of that document by the classification model 170. The server 106 is configured to “adjust” the classification model 170 based on a difference between the label 228 and the prediction value 450 (ground-truth vs. prediction).

As previously alluded to, the server 106 may perform the adjustment of the classification model 170 in different ways. For example, the server 106 may be configured to implement a gradient boosting technique for adjusting the classification model 170. In another example, the server 106 may be configured to implement a penalty function which is configured to adjust the classification model 170 based on the difference between the label 228 and the prediction value 450. Needless to say, the manner in which the server 106 may be configured to implement the gradient boosting technique and/or the penalty function may depend on whether the classification model 170 is being trained for performing binary classification of digital objects or multi-class classification of digital objects.

With reference to FIG. 5, there is depicted a single in-use iteration of the in-use phase of the (trained) classification model 170. Naturally, the in-use phase of the classification model 170 may comprise a large number of in-use iterations that are performed similarly to the single in-use iteration depicted in FIG. 5. Generally speaking, during a given in-use iteration, the classification model 170 is inputted with in-use data about a given in-use object. For example, a given in-use object may be a document. In another example, the given in-use object may be a document-query pair. Irrespective of the nature of the in-use object, the in-use data may be indicative of one or more features representative of the given in-use object.

Let it be assumed that that the server 106 is to classify a given in-use document associated with in-use data 500 comprising textual data 502 associated with the given in-use document, and embedding-based data 504 associated with the given in-use document.

The server 106 is configured to access the database system 150 and retrieve textual data 540 and embedding-based data 545 associated with the order sequence training examples 270. It should be noted that the server 106 may be configured to retrieve the textual data 540 and the embedding-based data 545 for generating a textual in-use feature 520 and an embedding-based in-use feature 530.

It is contemplated that the textual feature generator 310 including the textual-analysis function 315 and the embedding-based feature generator 320 including the embedding-analysis function 325 may be employed for generating the textual in-use feature 520 and the embedding-based in-use feature 530, respectively, similarly to how they are employed by the server 106 for generating textual training features and embedding-based training features, respectively. However, it should be noted that the textual data 540 and the embedding-based data 545 to be used for generating the textual in-use feature 520 and the embedding-based in-use feature 530, respectively, is associated with all training examples in the ordered sequence of training examples 270. In other words, it can be said that, for generating a given textual in-use feature for a given in-use object, all training objects that have been used for training are considered as preceding objects to the given in-use object.

The server 106 is configured to generate an in-use dataset 510 for the given in-use document comprising the textual data 502, the embedding-based data 504, the textual in-use feature 520 and the embedding-based in-use feature 530. The server 106 is configured to input the in-use dataset 510 into the (now-trained) classification model 170. In response, the classification model 170 is configured to generate an in-use prediction value 550 indicative of a predicted class of the given in-use document.

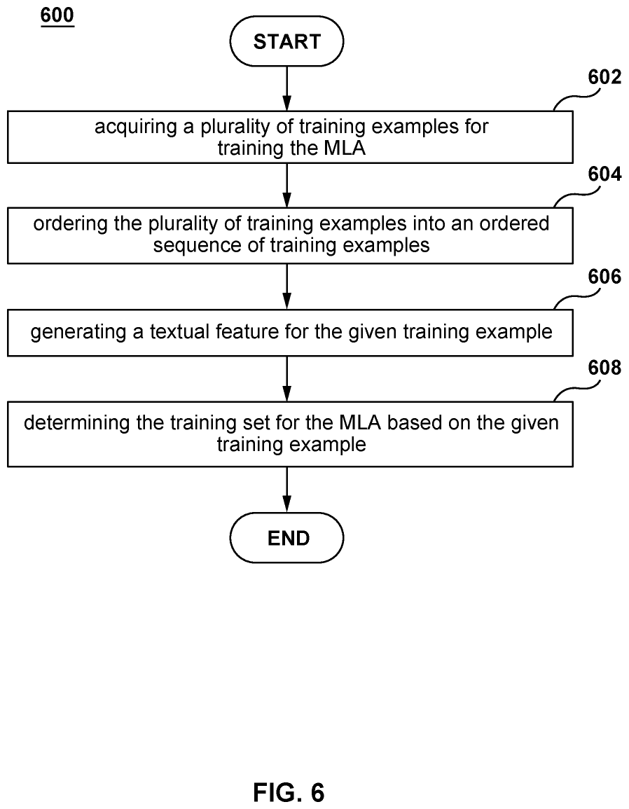

With reference to FIG. 6, in some embodiments of the present technology, the server 106 may be configured to execute a method 600 of determining a given training set for training the classification model 170. Various steps of the method 600 will now be described.

### STEP 602: Acquiring a Plurality of Training Examples for Training the MLA

The method 600 begins at step 602 with the server 106 configured to acquire the plurality of training examples 250 for training the MLA (the classification model 170). As mentioned above, training examples are associated with respective digital objects and comprises information about the respective digital objects.

It should be noted that a given training example may comprise textual data associated with a respective object and an indication of a ground-truth class of the respective object. For example, the digital object may be a digital document providable as a search result in response to a query, such as a query submitted to a given search engine. In this example, the textual data in the respective training example may comprise header text, body text, footer text, an HTML file, and the like associated with the given digital document. In another example, the object may be a digital item recommendable to a user of a given content recommendation system. In this example, the textual data in the respective training example may comprise item description, user reviews, and the like associated with the given digital item. In this example, the digital item may be a digital advertisement and the textual data in the respective training example may comprise one or more texts associated with the given digital advertisement. In a further example, the digital object may be an email destined to a user of a given email platform. In this example, the textual data in the respective training example may comprise text in the email body, in the email header, in one or more attachments, and the like associated with the given email.

It should be noted that the MLA is to be trained for performing classification of digital objects. In one example, the classification model 170 may be trained to perform binary classification of digital objects, such as determining whether a given email is “spam” or “non-spam”. In another example, the classification model 170 may be trained to perform multi-class classification of objects, such as determining whether a given digital document is related to “news” “science” “politics” or “sports”. Selection of classes may be performed by the operator of the server 106 and may depend on inter alia specific implementations of the present technology. It is contemplated that the classification model 170 may be implemented in a verity of ways. In at least one embodiment, the classification model 170 may be a decision-tree type MLA.

### STEP 604: Ordering the Plurality of Training Examples Into an Ordered Sequence of Training Examples

The method 600 continues to step 604 with the server 106 configured to order the plurality of training examples 250 into the ordered sequence of training examples 270. It should be noted that a given training example having previous training examples in the ordered sequence and subsequent training examples in the ordered sequence.

In some embodiments, the server 106 may be configured to randomly order the plurality of training examples 250—that is, the ordered sequence of training examples 270 may be a randomly-determined order of training examples. In other embodiments, the server 106 may be configured to order the plurality of training examples 250 based on one or more object-inherent characteristic associated with the respective objects. For example, the server 106 may be configured to use the creation date of respective digital document for ordering the plurality of training examples 250. As such, the ordered sequence of training examples 270 may be a sequence of training examples ordered from the “most old” digital document to the “most fresh” digital document. In another example, the server 106 may be configured to use a purchase date of respective digital items for ordering the plurality of training examples 250. As such, the ordered sequence of training examples 270 may be a sequence of training examples ordered from the “most recently” purchased digital item to the “less recently” purchased digital item.

### STEP 606: Generating a Textual Feature for the Given Training Example

The method 600 continues to step 606 with the server 106 configured to generate, by the server, the textual feature 330 for the training example 220 based on the textual data 224 from the training example 220 and the textual data and the labels of only the previous training examples in the ordered sequence without taking into account textual data in the subsequent training examples (that is, the textual data 284 and the labels of the respective training examples and the textual data 214 and the label 218).

In some embodiments, the server 106 may be configured to compute one or more statistical features on the textual data 224, and on the textual data 284 and 214. For example, the server 106 may be configured to compute one or more statistical features for the textual data 224 associated with the training example 220, and one or more statistical features for the textual data associated with the respective previous training examples. It is contemplated that the server 106 may be configured to generate the textual training feature 330 as a combination of one or more statistical features for the textual data 224 and the one or more statistical features for the textual data associated with the respective previous training examples.

The one or more pre-determined types of statistical features to be computed by the server 106 may be determined by the operator of the server 106. It is contemplated that the server 106 may be configured to compute one or more pre-determined types of statistical features based on textual data such that, when the one or more pre-determined types of statistical features for the textual data 224 and the one or more pre-determined types of statistical features for the textual data associated with the respective previous training examples are combined by the server 106, the resulting textual training feature 330 is a given similarity feature between the textual data 224 and the textual data of the previous training examples.

It is contemplated that the one or more pre-determined types of statistical features computed based the textual data associated with the respective previous training examples may be class-specific statistical features. For example, the statistical features computed based the textual data associated with the respective previous training examples may comprise: (i) a first statistical feature computed based on textual data associated with a first subset of previous training examples belonging to a first class (indicated by respective labels), and (ii) a second statistical feature computed based on textual data associated with a second subset of previous training examples belonging to a second class (indicated by respective labels).

In at least some embodiments of the present technology, the server 106 may be configured to generate more than one textual feature for a given training example 220 similarly to how the server 106 is configured to generate the textual feature 330. For example, the more than one textual features can be generated by the server 106 as respective combinations of the statistical features from the textual data 224 and the statistical features from the textual data associated with the respective previous training examples.

### STEP 608: Determining the Training Set for the MLA Based on the Given Training Example

The method 600 continues to step 608 with the server 106 configured to determine a given training set for the MLA based on the given training example. The training set has a training input and a label. The training input includes the textual feature 330 (or a plurality of textual features generated similarly to how the textual feature 330 is generated), and the label is representative of the ground-truth class of the respective object. In some embodiments of the present technology, it should be noted that the training input may further include the textual data of the respective object.

The server 106 may also be configured to generate a plurality of training sets for the training examples in the ordered sequence of training examples 270 similarly to how the server 106 is configured to generate a given training set for the training example 220. It is contemplated that data that the server 106 is configured to determine/generate during the generation process of the plurality of training sets can be stored in the database system 150.

It is contemplated that the server 106 may be configured to train the classification model 170 based on the so-determined training set. For example, the server 106 may provide the MLA with training inputs for generating respective predicted classes and such that they correspond to the respective ground-truth classes.

The server 106 may also be configured to use the so-trained classification model 170 during its in-use phase for classifying one or more digital objects of the plurality of online services 160. For example, the server 106 may acquire a given in-use example for the classification model 170 including textual data associated with the in-use object and may generate one or more in-use textual features for the given in-use example. The server 106 may generate the one or more in-use textual features based on the textual data of the given in-use example and textual data stored in the database system 150. In one example, the server 106 may use the textual data associated with respective ones from the ordered sequence of training examples 270. The server 106 may then input the textual data of the respective in-use object and the respective one or more in-use textual features into the classification model 170 that in response determines a predicted class of the in-use object.

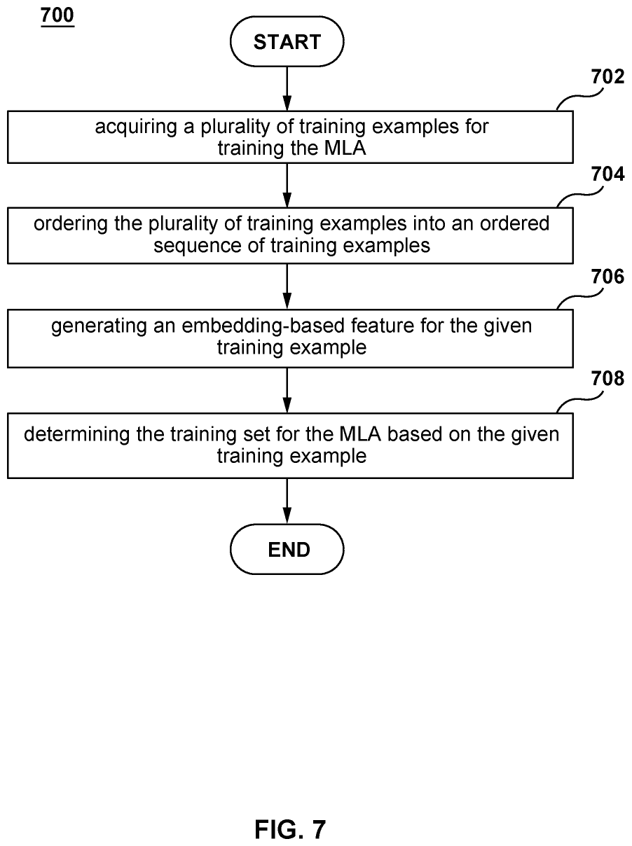

With reference to FIG. 7, in some embodiments of the present technology, the server 106 may be configured to execute a method 700 of determining a given training set for training the classification model 170. Various steps of the method 700 will now be described.

### STEP 702: Acquiring a Plurality of Training Examples for Training the MLA

The method 700 begins at step 702 with the server 106 configured to acquire the plurality of training examples 250 for training the MLA (the classification model 170). As mentioned above, training examples are associated with respective digital objects and comprises information about the respective digital objects.

It should be noted that a given training example may comprise embedding-based data associated with a respective object and an indication of a ground-truth class of the respective object. For example, the digital object may be a digital document providable as a search result in response to a query, such as a query submitted to a given search engine. In this example, the embedding-based data in the respective training example may comprise one or more embeddings (vectors) generated based on header text, body text, and/or footer text associated with the given digital document. In another example, the object may be a digital item recommendable to a user of a given content recommendation system. In this example, the embedding-based data in the respective training example may comprise one or more embeddings generated based on item description, and/or user reviews associated with the given digital item.

The server 106 may be configured to generate embedding-based data by employing at least one of: an embedding layer of a trained NN, a word2vec algorithm, and a GloVe algorithm. It is contemplated that the server 106 may make use of other embedding generation techniques as is known in the art.

STEP 704: Ordering the Plurality of Training Examples Into an Ordered Sequence of Training Examples

The method 600 continues to step 604 with the server 106 configured to order the plurality of training examples 250 into the ordered sequence of training examples 270. It should be noted that a given training example having previous training examples in the ordered sequence and subsequent training examples in the ordered sequence.

In some embodiments, the server 106 may be configured to randomly order the plurality of training examples 250—that is, the ordered sequence of training examples 270 may be a randomly-determined order of training examples. In other embodiments, the server 106 may be configured to order the plurality of training examples 250 based on one or more object-inherent characteristic associated with the respective objects. For example, the server 106 may be configured to use the creation date of respective digital document for ordering the plurality of training examples 250. As such, the ordered sequence of training examples 270 may be a sequence of training examples ordered from the “most old” digital document to the “most fresh” digital document. In another example, the server 106 may be configured to use a purchase date of respective digital items for ordering the plurality of training examples 250. As such, the ordered sequence of training examples 270 may be a sequence of training examples ordered from the “most recently” purchased digital item to the “less recently” purchased digital item.

### STEP 706: Generating an Embedding-Based Feature for the Given Training Example

The method 700 continues to step 706 with the server 106 configured to generate, by the server, the embedding-based feature 340 for the training example 220 based on the embedding-based data 226 from the training example 220 and the embedding-based data (embeddings) and the respective labels of only the previous training examples in the ordered sequence without taking into account embedding-based data in the subsequent training examples (that is, the embedding-based data 286 and the labels of the respective training examples and the embedding-based data 216 with the label 218).

The server 106 may be configured to perform an information retrieval operation on an embedding-based dataset (e.g., a plurality of embeddings). For example, the server 106 may be configured to compute one or more statistical features for the embedding-based data 226 associated with the training example 220, and one or more statistical features for the embedding-based data associated with the respective previous training examples. It is contemplated that the server 106 may be configured to generate the embedding-based training feature 340 as a combination of one or more statistical features for the embedding-based data 226 and the one or more statistical features for the embedding-based data associated with the respective previous training examples.

In some embodiments, the server 106 may be configured to compute one or more pre-determined types of statistical features based on embedding-based data such that, when the one or more pre-determined types of statistical features for the embedding-based data 226 and the one or more pre-determined types of statistical features for the embedding-based data associated with the respective previous training examples are combined by the server 106, the resulting embedding-based training feature 340 is at least one of, but not limited to: distance between a given embedding for the training example 220 and a cluster-center computed for embeddings from the previous training examples that are of a same class as the training example, and distance between the given embedding for the training example 220 and an other cluster-center computed for embeddings from the previous training examples that are of a different class than the training example 220.

It should be noted that the server 106 may be configured to determine a variety of embedding-based similarity features. For example, it is contemplated that the server 106 may be configured to determine an embedding-based similarity feature that is indicative of at least one of: (i) a cosine or L2 distance of sample's embedding to an average embedding of a particular class, L2 distance to the nearest or k-th nearest neighbor from a particular class, a linear discriminant analysis value, and the like.

In at least some embodiments of the present technology, the server 106 may be configured to generate more than one embedding-based feature for a given training example 220 similarly to how the server 106 is configured to generate the embedding-based feature 340. For example, the more than one embedding-based features can be generated by the server 106 as respective combinations of the statistical features from the embedding-based data 226 and the statistical features from the embedding-based data associated with the respective previous training examples.

### STEP 708: Determining the Training Set for the MLA Based on the Given Training Example

The method 700 continues to step 708 with the server 106 configured to determine a given training set for the MLA based on the given training example. The training set has a training input and a label. The training input includes the embedding-based feature 340 (or a plurality of embedding-based features generated similarly to how the embedding-based feature 340 is generated), and the label is representative of the ground-truth class of the respective object. In some embodiments of the present technology, the training input may further include the embedding-based data of the respective object.

The server 106 may also be configured to generate a plurality of training sets for the training examples in the ordered sequence of training examples 270 similarly to how the server 106 is configured to generate a given training set for the training example 220. It is contemplated that data that the server 106 is configured to determine/generate during the generation process of the plurality of training sets can be stored in the database system 150.

It is contemplated that the server 106 may be configured to train the classification model 170 based on the so-determined training set. For example, the server 106 may provide the MLA with training inputs for generating respective predicted classes and such that they correspond to the respective ground-truth classes.

In some embodiments of the present technology, the server 106 may be configured to generate one or more textual in-use features and one or more embedding-based in-use features for a given in-use digital object similarly to what has been described above. The server 106 may also be configured to use the one or more textual in-use features and the one or more embedding-based in-use features for classifying the given in-use digital object.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Some of these steps and signal sending-receiving are well known in the art and, as such, have been omitted in certain portions of this description for the sake of simplicity. The signals can be sent-received using optical means (such as a fibre-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of determining a training set for training a Machine Learning Algorithm (MLA) to perform classification of the digital objects, the method executable by a server, the server executing the MLA, the method comprising:
acquiring, by the server, a plurality of training examples for training the MLA,
a given training example including textual data associated with a respective digital object and an indication of a ground-truth class of the respective object;
ordering, by the server, the plurality of training examples into an ordered sequence of training examples,
the given training example having previous training examples in the ordered sequence and subsequent training examples in the ordered sequence;
generating, by the server, a textual feature for the given training example based on the textual data in the given training example and the textual data and the ground-truth classes of only the previous training examples in the ordered sequence without taking into account textual data in the subsequent training examples;
determining, by the server, the training set for the MLA based on the given training example,
the training set having a training input and a label,
the training input including the textual feature, the label being representative of the ground-truth class of the respective object.

2. The method of claim 1, wherein the training input further includes the textual data of the respective object, the textual data for inputting with the textual feature into the MLA.

3. The method of claim 1, wherein the method further comprises training, by the server, the MLA based on the training set, the MLA being trained to use inputs for generating respective predicted classes.

4. The method of claim 1, wherein the digital object is a digital document providable as a search result in response to a query.

5. The method of claim 1, wherein the digital object is a digital item recommendable to a user of a content recommendation system.

6. The method of claim 1, wherein the digital object is an email destined to a user of an email platform.

7. The method of claim 1, wherein the method further comprises storing, by the server, data indicative of the plurality of training examples in a storage.

8. The method of claim 1, wherein the generating the textual feature comprises employing, by the server, at least one of: a Naïve Bayes function, a Term-Frequency-Inverse-Document-Frequency (TF-IDF) function, and a Best-Matching-25 (BM25) function.

9. The method of claim 1, wherein the method further comprises storing, by the server, data indicative of a plurality of training sets in a storage, the plurality of training sets including the training set.

10. The method of claim 9, wherein the method further comprises:
acquiring, by the server, a given in-use example for the MLA,
the given in-use example including textual data associated with a respective in-use object;
generating, by the server, an in-use textual feature for the given in-use example based on the textual data in the given in-use example and the textual data stored in the storage;
inputting, by the server, a given in-use input into the MLA, the given in-use input including the in-use textual feature,
the MLA being configured to determine a predicted class of the respective in-use object.

11. The method of claim 10, wherein the given in-use input further includes the textual data of the respective in-use object.

12. The method of claim 1, wherein the MLA is trained to perform binary classification of objects.

13. The method of claim 1, wherein the MLA is trained to perform multi-class classification of objects.

14. The method of claim 1, wherein the MLA is of a decision-tree type.

15. A method of determining a training set for training a Machine Learning Algorithm (MLA) to perform classification of the digital objects, the method executable by a server, the server executing the MLA, the method comprising:
acquiring, by the server, a plurality of training examples for training the MLA,
a given training example including an embedding associated with a respective object and an indication of a ground-truth class of the respective object;
ordering, by the server, the plurality of training examples into an ordered sequence of training examples,
the given training example having previous training examples in the ordered sequence and subsequent training examples in the ordered sequence;
generating, by the server, an embedding-based feature for the given training example based on the embedding in the given training example and the embeddings and the ground-truth classes of only the previous training examples in the ordered sequence without taking into account embeddings in the subsequent training examples;
determining, by the server, the training set for the MLA based on the given training example, the training set having a training input and a label,
the training input including the embedding-based feature, the label being representative of the ground-truth class of the respective object.

16. The method of claim 15, wherein the training input further includes the embedding of the respective object, the embedding for inputting with the embedding-based feature into the MLA.

17. The method of claim 15, wherein the method further comprises training, by the server, the MLA based on the training set, the MLA being trained to use inputs for generating respective predicted classes.

18. The method of claim 15, wherein the object is a digital document providable as a search result in response to a query.

19. The method of claim 15, wherein the object is a digital item recommendable to a user of a content recommendation system.

20. The method of claim 15, wherein the object is an email destined to a user of an email platform.

21. The method of claim 15, wherein the method further comprises storing, by the server, data indicative of the plurality of training examples in a storage.

22. The method of claim 15, wherein the generating the embedding-based feature comprises determining, by the server, at least one of: a cosine distance between the embedding and an average embedding for a given class of the previous training examples, a euclidean distance between the embedding and K number of nearest neighbors from the given class of the previous training examples.

23. The method of claim 15, wherein the method further comprises generating, by the server, the embedding for the given training example based on textual data associated with the given object.

24. The method of claim 23, wherein the embedding is generated by employing at least one of: a word2vec algorithm, a fastText algorithm, and a GloVe algorithm.

25. The method of claim 15, wherein the method further comprises generating, by the server, the embedding for the given training example based on image data associated with the given object.

26. The method of claim 15, wherein the method further comprises storing, by the server, data indicative of a plurality of training sets in a storage, the plurality of training sets including the training set.

27. The method of claim 26, wherein the method further comprises:
acquiring, by the server, a given in-use example for the MLA,
the given in-use example including an in-use embedding associated with a respective in-use object;
generating, by the server, an in-use embedding-based feature for the given in-use example based on the in-use embedding in the given in-use example and embedding-based data stored in the storage;
inputting, by the server, a given in-use input into the MLA, the given in-use input including the in-use embedding-based feature,
the MLA being configured to determine a predicted class of the respective in-use object.

28. A method of determining a training set for training a Machine Learning Algorithm (MLA) to perform classification of the digital objects, the method executable by a server, the server executing the MLA, the method comprising:
acquiring, by the server, a plurality of training examples for training the MLA,
a given training example including object-specific data associated with a respective digital object and an indication of a ground-truth class of the respective object;
ordering, by the server, the plurality of training examples into an ordered sequence of training examples,
the given training example having previous training examples in the ordered sequence and subsequent training examples in the ordered sequence;
clustering, by the server, the previous training examples into at least two clusters of previous training examples in a multidimensional space,
previous training examples in a given cluster being associated with a first ground-truth class;
generating, by the server, a similarity feature for the given training example based on a distance between the given cluster and the given training example in the multidimensional space,
the similarity feature being indicative of a similarity between the given training example and the previous training examples of the first ground-truth class;
determining, by the server, the training set for the MLA based on the given training example,
the training set having a training input and a label,
the training input including the similarity feature, the label being representative of the ground-truth class of the respective object.
